(19) United States
(12) Patent Application Publication
(10) Pub. No.: US 2020/0248864 A1
(43) Pub. Date: Aug. 6, 2020

(54) Fabric Art Hanging Apparatus And Method Of Use

(71) Applicant: Michael Rivers Dickinson, Hornsby (AU)

(72) Inventor: Michael Rivers Dickinson, Hornsby (AU)

(21) Appl. No.: 15/774,383

(22) PCT Filed: Nov. 8, 2016
(86) PCT No.: PCT/AU2016/051067

§ 371 Date: May 8, 2018

(30) Foreign Application Priority Data
Nov. 8, 2015 (AU) 2015904577
Jul. 26, 2016 (AU) 2016902941

(51) Int. Cl. F16M 13/02; F16B 1/00; F16B 2/22

(52) U.S. Cl. CPC F16M 13/02; F16B 2001/0028; F16B 2/22; F16B 1/00

(57) ABSTRACT

A fabric art hanging apparatus (402) is disclosed which is arranged in use for mounting an item of fabric art (403) at a support structure such as a wall or other structure. The fabric art hanging apparatus (402) comprises a thin panel such as PVC sheet having opposed major faces, with a layer of a sewable material such as grosgrain fabric affixed by gluing to one face of the panel, and with the layer of sewable material arranged with at least one portion which extends beyond a perimeter of the panel. The portion of the layer of sewable material which extends beyond the perimeter of the panel is arranged in use for sewing to the item of fabric art. The outer face of the panel, which is opposite to the face glued to the sewable material, is adapted in use for locating a prior art mounting device (401) thereat, for example Commander brand strips or double-sided tape, depending on the user requirements. The fabric art hanging apparatus (402) therefore provides a re-usable item which interfaces between an item of fabric art and a hanging surface, and is adapted to join each one of them in a non-damaging way.

### TECHNICAL FIELD

This disclosure relates to a hanging apparatus and to a method of locating the hanging apparatus at a sewable item of fabric art, for the purpose of fitting a mounting device to the fabric art item so that the fabric art item can be displayed.

### BACKGROUND OF THE DISCLOSURE

Fastener systems, which use or incorporate adhesion, have been developed to assist the joining permanently or semi-permanently of a wide variety of materials in an equally diverse range of applications in sporting, domestic, industrial and military activities. The required degree of fastener adhesion provided depends on the adhesion formula of the fastener being used, the purpose and the material to be adhered to. The degree of adhesion required varies on the activity being undertaken, environmental and safety considerations.

For example, Blu-Tack brand pressure sensitive adhesive putty is used as a fastener system in a multitude of contexts, while Commander brand hook-and-loop fastener strips caters to a different set of criteria in application contexts where Blu-Tack putty would not be appropriate. Both these systems have limitations, cost considerations, and functionality factors, which weigh into the mix of selection criteria. Also, these example prior art fasteners have limited value when used with fabrics or other materials for which their adhesive formulations are not optimised. Adhesive formulations are carefully developed by manufacturers to cover the expected usage of the fastener system.

The use of sewing, pins and safety pins is a well known and accepted fastening system for fabrics and other material that lend themselves to being pierced. As an adhesive system for many blends of fabrics, heat-activated adhesives are also understood and utilised within industry. For example, pre-coated adhesive patches for mending tears and holes in clothing are commercially available and these patches can be applied with the use of a domestic iron, however these patches are not designed to have any external pressure or force applied to them in use.

Various forms of hanging apparatus are known for displaying items of fabric art in domestic homes, offices, museums, retail stores, and the like. The usual location is for display on a wall, and usually contingent on neither damaging the wall or the item of fabric art, which itself can be delicate in nature, and may be highly valuable. Directly clamping or gluing an object to a supporting frame is undesirable because of the physical damage which can result to the fabric art item. A gluing process places chemical bonding agents in intimate contact with a textile surface. Strong adhesive agents are not easily removed, leave undesired residue and the contact creates surface damage and archival problems. Weak or removable adhesive agents can still cause surface damage and archival problems, but they also do not create a useful or reliable load carrying bond because the adhesive mechanism is not designed to interact with the open, porous surface textile surfaces present.

One fabric art hanging apparatus is provided in U.S. Pat. No. 6,219,892 which avoids gluing. A sheet of interface material is joined to the fabric art by stitching, and the interface sheet is also stitched around a rod which in use is clamped between two clamp bars, one of which is mounted proud of a supporting wall. The interface material hangs over the top of the outer clamp bar, and downwardly to support the fabric art item.

The apparatus disclosed in U.S. Pat. No. 6,219,892 is cumbersome to use, and because it comprises many parts, some of which require actuation in use, it would be expensive to manufacture and ship to customers. The use of a rod to achieve a stiff upper surface region of the item of fabric art can produce puckering along the top edge of the item being hung. Additionally, this prior art display apparatus cannot hang the fabric art flush with the supporting wall, as would be usually the case for any artwork, because of the width of the two clamp bars and clamping mechanism protruding from the wall. This looks unsightly, and can leave the hanging fabric art exposed to movement by the action of a breeze, or from passers-by which is unsuitable for example, for a delicate art work such as a tapestry. When time comes to remove the fabric art from the wall, a user needs to have the dexterity to get behind the fabric art without damaging it, in order to access the clamp bar mechanism and to unclamp the bars and release both the rod and the item of fabric art together. Once this has been accomplished, both the fabric art item and the rod to which it is joined, need to be moved into a different position so that the rod can be slidingly removed from the interface sheet, and the fabric art released, again all without damaging the fabric art.

There is a need for a simplified system which allows for joining of an item of fabric art with available mounting or fastening systems, to enable the conventional visual display of the fabric art at a supporting surface, and be a system to which considerable force or pressure can be applied without demounting or dislodging the item of fabric art once it is mounted for display.

### SUMMARY

In a first aspect there is provided a fabric art hanging apparatus, arranged in use for mounting an item of fabric art at a support structure, the hanging apparatus comprising: a panel having opposed major faces; a layer of a sewable material affixed to one face of the panel; and the layer of sewable material arranged with at least one portion extending beyond a perimeter of the panel; wherein the face of the panel opposite to the one face is adapted in use for locating a mounting device thereat, and the portion of the layer of sewable material is arranged in use for sewing to the item of fabric art.

When the term “fabric art” is used in this specification, it can include items such as a quilt, tapestry, embroidery, needlepoint, blanket, carpet, rug, curtain, flag and cloth banner. In many cases these are in a planar form, or as a large sheet of material, with at least one elongate dimension and can be quite heavy. In other forms, the fabric art can be a physical art object having a fabric or sewable exterior surface, for example a craft object like a stuffed soft toy, or a souvenir football jersey, or a particular item of unique clothing for display. In most cases, the requirement for a hanging apparatus for such an item is to display it on a wall, or another vertical surface such as a door, bed end, wardrobe or across a window.

When the term “sewable” is used in this specification in relation to a material, it incorporates those materials which are capable of being fastened by stitching, as with a needle and thread or by a sewing machine, but which can also be sewn by other linkage means which can pierce or interlink both the item of fabric art and the sewable material, such as pins, staples, closures, fasteners, buttons or attachment clips.

In some embodiments, the layer of sewable material is affixed to the one face of the panel by an adhesive substance. Such a substance can be a heat set adhesive glue, such as PES copolymer adhesive. The adhesive glue can also be of other types such as a curable hot melt, a urethane, a moisture activated glue, a radiation activated glue, a UV activated glue or a pressure sensitive glue. In still other embodiments of affixing the panel to the sewable material, the layer of sewable material can be sewn, stitched, pinned or otherwise fastened to the panel, in order to interlink or to join the sewable material to the panel by a physical bond, so that in use these items are moved together as one.

In some embodiments, the panel is of an elongate planar shape, having two opposed elongate sides. In some embodiments, the panel is formed from a flexible and bendable resilient material, able to be deformed orthogonally relative to its central elongate axis. This means that the fabric art hanging apparatus can be mounted via the mounting devices to a curved surface, for example at a curved interior wall, or used to mount a curtain to a curved car window, or at the curved surfaces encountered in the interior of a boat, or to the exterior of a barrel.

In one form, the layer of sewable material is arranged with portions extending beyond each of the two opposed elongate sides of the panel. These side portions can be strips of material which are sufficient in width to allow sewing, stitching, pinning or fastening to the item of fabric art.

In some embodiments, the panel is formed from a PET polyester plastic material. PET polyester plastic has a smooth surface and is suitable for bonding to many types of modern adhesive glues. This adaptation allows joining to many types of mounting devices such as hooks, clasps, adhesive tapes, Commander brand hook and loop fasteners, and the like. The panel is also bendable and flexible, and comes in a thin sheet form. Other types of plastics and rigid or semi-rigid materials can also be suitable.

In one form, the panel is of a width between opposed elongate sides sufficient to prevent the panel from twisting along its length in use. When the panels are used to support a weight using one or more mounting devices, it is advantageous that it has elongate rigidity and does not deform in a lateral direction and sag, which could make the hanging fabric art being supported by at the panel appear wrinkled or unsightly.

In some embodiments, the sewable material is made of a fabric. In one form, the sewable material is formed from a grosgrain narrow fabric. Grosgrain stitch fabric has a strong weave which does not fray easily, and can be pinned or sewn without distortion, which means it can be re-used multiple times. Other fabric materials can also be suitable for re-use.

In some embodiments, the hanging apparatus comprises a plurality of panels, arranged on the layer of sewable material in a spaced apart manner. In an alternative embodiment, the hanging apparatus comprises a panel arranged on the layer of sewable material, the panel having any one or more of the following lines of: breakage, folding, perforation or frangibility.

In some embodiments, the layer of sewable material is a strip of material, and the or each of the panels are of an elongate planar shape being arranged with portions extending beyond each of the two opposed elongate sides of the panels. It is along each portion at which the hanging apparatus is sewable to the item of fabric art.

The use of a strip of material and/or a plurality of panels means that the hanging apparatus can be used to hang an elongate object, or to hang multiple objects, along its length, depending upon on its orientation in use. In one particular embodiment, each panel has a central axis and is arranged in an end-to-end, axially aligned manner with one or more other panels. The use of a strip with spaced-apart panels also means that the hanging apparatus can be folded about the sections of sewable material which are located between the adjacent panels, in a concertina-like manner, so that the panels can overlay one another in a stack, for sliding placement into packaging. The use of a plurality of aligned panels, or an elongate strip with fracture lines or fold lines, can spread the hanging load along the elongate length of the hanging apparatus into individual load bearing segments. This reduces the stress on the affixing means between the panel and the layer of sewable material at any one point. By creating less glue shear forces, and by increasing creep strength of the finished article, this in turn can allow for the use of less expensive affixing means. The other benefit is that the hanging apparatus can be concertina folded prior to use, for placement in compact packaging for shipment.

In other forms the hanging apparatus comprises a plurality of panels, arranged on a sheet of sewable material in a spaced apart manner, and the sewable material can simply be cut using scissors to suit the particular size and shape of the item of fabric art. This means that it has adaptability to be trimmed, cut or even re-joined to accommodate the hanging of an item of fabric art of irregular shape. The system also allows the layer of sewable material and the panel to be cut and arranged to be attached at two corners to deliberately allow a draped presentation of a fabric art product such as a flag. No other known fabric art hanging apparatus can be cut to length with scissors. In other forms, the panels can be shaped in various ways, for example, circles, squares, and the like. The panels may be of varying thicknesses, provided that the panels themselves are sufficiently strong and fit for purpose, as well as able to maintain an adhesive bond to the layer of sewable material and to act as a platform for supporting a mounting device with adhesive.

In a second aspect, there is provided in combination, a kit of parts comprising: a fabric art hanging apparatus as defined in the first aspect; and one or more mounting devices, wherein the parts are arranged to lie side by side in a plane, for sliding receipt in a standard DL or DLX size mailing envelope.

A strip of sewable material, when joined to a series of panels, can form an elongate version of a fabric art hanging apparatus, which conveniently can be folded to form a sufficiently thin article which can be legally posted in standard size envelopes, along with a number of selected mounting devices of no greater thickness than the folded strip and panels. Consequently, the hanging apparatus of the present disclosure is inexpensive to ship to customers. By comparison, the prior art apparatus which uses a clamped rod to suspend an item of fabric art would have a much greater cost of commercial packaging and shipping, which would deter potential users in domestic situations, for example.

In a third aspect, there is provided a method of locating a fabric art hanging apparatus at an item of fabric art, where the fabric art hanging apparatus is as defined in the first aspect; the method comprising the steps of: sewing the portion of the layer of sewable material to the item of fabric art; and locating a mounting device at the face of the panel opposite to the one face.

Advantageously, the embodiments of the hanging apparatus as described herein can provide a reusable means for mounting an item of fabric art, such as a tapestry, carpet, flag, quilt or other woven product, at a vertical surface such as a wall having a wall mounting, for example, without damaging either the fabric art item or the wall. The sewable material can be stitched or joined to the item of fabric art in a non-damaging way, and the panel surface of the hanging apparatus can be fitted with one or more mounting devices which can be engaged at the vertical surface, to allow the fabric art to hang in such a way as to appear flush with that vertical surface.

The fabric art hanging apparatus of the present disclosure therefore provides a re-usable item which interfaces between an item of fabric art and a vertical surface, and is adapted to join each one of them in a non-damaging way. The mounting devices used are typically prior art fasteners, and the selection of an appropriate fastener will depend on the user usage requirements and should follow the limits and usage specifications of the selected device.

The fabric art hanging apparatus of the present disclosure can be used for a single point attachment/mounting, but when produced over a length in strip form creates enough rigidity through the points of attachment to the receiving surface (for example, a wall) to eliminate the need for the addition of a rigid rod, as seen in patent U.S. Pat. No. 6,219,892, or a frame as seen in other traditional textile mounting systems. The apparatus of the present disclosure also does not make use of any wall-damaging nails or screws for fastening clamping brackets to a wall, as seen in U.S. Pat. No. 6,219,892.

Because of its ability to be configured to extend over length in a strip form, with three small thickness components (i.e. layer of panel, layer of sewable material, and a thin layer of glue between them as affixing means), the apparatus of the present disclosure is therefore able to be arranged to provide a mounting system which is flush with the supporting wall, which means it can remain hidden from view and not detract from the fabric art on display. This wall flush mounting also has the advantage of limiting the movement of the item of fabric art as moving air cannot get behind the item. When time comes to remove the item of fabric art from the wall, a user only needs to uncouple the mounting device to remove the item of fabric art from the supporting surface (for example, decouple a series of Commander brand Velcro strip pairs positioned on the panel and on the supporting surface). This is simpler than apparatus of U.S. Pat. No. 6,219,892 which requires unclamping of a supporting rod from a spring-loaded clamping mechanism, lifting of the rod and the fabric art item together, and then slidingly removing the rod from the fabric art.

In another example of its use, embodiments of the hanging apparatus can be used to mount objects onto a sewable material. For example, the layer of sewable material joined to one face of the panel can be sewn, stitched or pinned to a canvas or fabric wall, such as the interior of a tent or marquee. In such an arrangement, the face of the panel opposite to the one face can have one or more mounting devices thereat, for example a hook to hang clothes or to tie a cord or rope to. The hanging apparatus can therefore provide a reusable interface with a sewable object, and provide a means to securely mount items at the sewable object.

Some embodiments disclosed herein provide a system to achieve attachment between the prior art fasteners, which use or incorporate adhesive, diversifying their application for use on fabric art products which their adhesive formulations have not been optimised for.

In some embodiments, there is provided a heat activated adhesive layer applied to a base material, but not limited to heat activated adhesion. In this embodiment a polyester base material is optimised by shape, thickness, chemical composition and mechanical characteristics, flexibility and durability to provide a desired bonding platform with the adhesive formulation of the prior art in fasteners. This is achieved with or without the base material receiving additional post treatment or additional layers of material to achieve an optimised attachment.

The base material is bonded to via an adhesive or attached through sewing, heat welding or other mechanical or chemical bonding technique to a sewable material, which is of a size that does not interfere with the adhesion of either the base material or the adhesive system of the prior art fastener. This produces a sewable/pin-able section, which facilitates temporary or permanent sewn/pinned attachment of the hanging apparatus to fabric products. Examples can include cushions, soft toys, banners, flags, quilts and tapestries.

Once the sewable material has been attached to the desired fabric art product, a mounting device in the form of a prior art fastener can be selected to meet the user usage requirements following the specific weight and usage requirements permitted by the prior art fastener.

Advantageously, this combination of sewable/pin-able material and backing material, which enhances prior art fastener usage possibilities, provides a relatively lightweight and inexpensive system which can be adapted to the diverse configurations of the prior art in fasteners. The hanging apparatus provides enhanced attachment possibilities for hanging fabric art, but requires no modification of the prior art fasteners to gain the new attachment possibilities.

In a fourth aspect, there is provided a mounting apparatus for mounting to a sewable object, the mounting apparatus comprising: a panel having an elongate planar shape, two opposed elongate sides, two opposed major faces, and any one or more of the following lines of: breakage, folding, perforation or frangibility; a layer of a sewable material joined to one face of the panel; and the layer of sewable material arranged with at least one portion extending beyond a perimeter of the panel; wherein the face of the panel opposite to the one face is adapted in use for locating a mounting device thereat, and the portion of the layer of sewable material is arranged in use for sewing to the sewable object.

In some embodiments, the layer of sewable material is a strip of material, being arranged with portions extending beyond each of the two opposed elongate sides of the panel. In some embodiments, the features of the mounting apparatus are otherwise the same as those of the fabric art hanging apparatus of the first aspect.

In a fifth aspect, there is provided in combination, a kit of parts comprising: a mounting apparatus as defined in the fourth aspect; and one or more mounting devices; wherein the parts are arranged to lie side by side in a plane, for sliding receipt in a standard DL or DLX size mailing envelope.

In a sixth aspect, there is provided a method of locating a mounting apparatus at a sewable object, where the mounting apparatus is as defined in the fourth aspect; the method comprising the steps of: sewing the portion of the layer of sewable material to the sewable object; and locating a mounting device at the face of the panel opposite to the one face.

In some embodiments, the combination of sewable/pin-able material and backing material will be selected to facilitate specific attachment qualities according to the level of attachment required.

In some embodiments, the combination of sewable/pin-able material and backing material comprises multiple materials layers, coatings or surface treatments to achieve the attachment objectives.

In some embodiments, the sewable/pin-able material and backing material comprises one or more additional layers of material or protective/presentation material to achieve attachment, presentation and useability objectives, but is not limited in number or type of additional layers.

In some embodiments, the product will be designed to complement the colour and stylistic features of specific attachment objectives.

In some embodiments elements will be displayed via placement on panel of the hanging apparatus, such as logos, instructions or special messages.

In some embodiments the panel material suitable for engaging with the prior art in fasteners will be sewable/pin-able or prepared to facilitate sewing.

In some embodiments the panel material suitable for engaging with the prior art in fasteners will be co-extruded with a sewable material to facilitate sewing/pinning.

In some embodiments, the combination of sewable/pin-able backing material and panel will be packaged as a product for a purpose designed application along with a specific fastener system.

In some embodiments, the combination of sewable/pin-able material and panel material will be packaged as a product providing a platform for a general range of prior art fastener systems.

In some embodiments the panel will be constructed to facilitate pin/safety pin attachment without the option for sewn attachment to the layer of sewable material fabric.

In some embodiments the panel will be constructed to use buttons or button holes as an attachment method instead of using direct sewn attachment to the layer of sewable material.

Other aspects, features, and advantages will become further apparent from the following detailed description when read in conjunction with the accompanying drawings which are a part of this disclosure and which illustrate, by way of example, principles of the inventions disclosed.

### DESCRIPTION OF THE FIGURES

The accompanying drawings facilitate an understanding of the various embodiments of a fabric art hanging apparatus:

FIG. 1 is a schematic perspective assembly view of an embodiment illustrating placement of the major components in relation to each other. A sewable area is shown, which is illustrated as being located to extend out on two sides of the panel, but could extend from just one single side or any number of sides up to and including all sides.

FIG. 2 is a schematic side elevation view. FIG. 2 illustrates one embodiment of a hanging apparatus assembled with its layer of sewable material prepared for fastening via sewing or pinning to a receiving material of an item of fabric art, and its upper surface available for receiving the adhesive base of a prior art mounting device.

FIG. 3 is a schematic side elevation view showing the process of mounting placement of the hanging apparatus after sewing attachment is made to the fabric art. A piece of Blu-Tack brand mounting device, or another form of prior art mounting device which incorporates adhesive as part of the fastening system, facilitates mounting to a wall.

FIGS. 4A and 4B are schematic perspective views. FIG. 4A illustrates one embodiment of a hanging apparatus with its (lowermost) sewable material surface prepared for fastening via sewing/pinning to a receiving item of fabric art and its exposed panel (uppermost) surface prepared for receiving an example of a temporary adhesive media, Blu-Tack brand or similar style mounting device. FIG. 4B illustrates the components of 4A assembled with the representative prior art mounting device, placed on the receptive uppermost panel surface.

FIGS. 5A and 5B are schematic perspective views. FIG. 5A illustrates one embodiment of a hanging apparatus with its (lowermost) sewable material surface prepared for fastening via sewing to a receiving item of fabric art and its exposed panel (uppermost) surface prepared for receiving an example of a clip style prior art mounting device. FIGS. 5A and 5B are representative of a prior art mounting device which incorporates adhesive. FIG. 5B illustrates the components of 5A assembled with the representative prior art mounting device when placed on the receptive uppermost panel surface.

FIGS. 6A and 6B are schematic perspective views. FIG. 6A illustrates one embodiment of a hanging apparatus with its (lowermost) sewable surface prepared for fastening via sewing to a receiving item of fabric art and its exposed panel (uppermost) surface prepared for receiving an example of a clip style prior art fastener. FIGS. 6A and 6B are representative of a prior art mounting device which incorporates adhesive, but with a hook and loop arrangement joining two halves of the mounting device. FIG. 6B illustrates the components of 6A assembled with the representative prior art mounting device when placed on the receptive uppermost panel surface.

FIG. 7 is a schematic perspective view. FIG. 7 illustrates one embodiment of the hanging apparatus with its upper surface prepared with graphic elements.

FIG. 8 is a schematic perspective view. FIG. 8 illustrates a variety of sewn approaches of the present disclosure, when attaching a panel by sewing (instead of affixing by gluing) directly to a layer of sewable material, where it is likely that one mode would be selected when producing a particular hanging apparatus. FIG. 8 also presents a variety of examples of prior art mounting devices in position for being adhered to a respective panel. This view is intended to be illustrative of the range of mounting devices possible for use (double sided tape, hook and loop fasteners, clips etc) as well as of the range of options for sewing joining the layer of sewable material to the panels, rather than how they would actually appear on a single item of fabric art, or only in the particular combinations depicted.

FIG. 9 is a schematic assembly cross-section view. FIG. 9 illustrates mounting procedure for a pin or safety pin only panel to a wall.

FIGS. 10A and 10B are schematic side views. FIGS. 10A and 10B illustrates a panel design and layout which entraps the pin point for safety and locks the pin in place with a removable press fit into a predetermined receiving position, to join the panel and the layer of sewable material.

FIG. 11 is a schematic perspective view. FIG. 11 illustrates one embodiment which utilises interlocking tabs, eliminating the need for additional processing, glues or heat fixing to create the panel. Pre-assembly of the panel could be by laser cut or press cut. FIG. 11 also illustrates the receiving action of a pin being inserted.

FIGS. 12A and 12B is a schematic side view of an embodiment which utilises a safety pin. FIGS. 12A and 12B illustrate the location of the safety pin and the procedure for attaching the panel to the layer of sewable material.

FIG. 13A is a schematic perspective view. FIG. 13A illustrates one embodiment which utilises slots suitable for injection moulding to create channels to hold a pin in place in the panel. It also illustrates the use of a friction position locking press fit, to hold the pin in place. FIG. 13B is a schematic cross section view of the embodiment illustrated in FIG. 13A.

FIGS. 14A and 14B are schematic perspective views. FIGS. 14A and 14B illustrate one embodiment which utilises a hook or receiving slot to anchor the pin to the panel. This embodiment is suited to mechanical or heat forming, extrusion or injection moulding.

FIGS. 15A and 15B are schematic perspective views. FIGS. 15A and 15B illustrate one embodiment which utilises a press fit, to anchor a pin to the panel.

FIG. 16 is a schematic perspective view. FIG. 16 illustrates a pin style panel fixing arrangement, which is using sewing, heat welding or glue in the assembly.

FIG. 17A is a schematic perspective view. FIG. 17A illustrates a multi-function hook system, which allows the use of pin and safety pin, but also allows the use of button or buttonhole as the attachment point to the layer of sewable material.

FIG. 17B is a schematic front view illustrating the hook feature engaged with a button and with a buttonhole.

FIG. 18 is a schematic perspective view. FIG. 18 is a double fold with the top fold designed to assist in the transfer of peel load and increase adhesion to the mounting surface. This embodiment is suitable for use of pin or safety pin.

FIG. 19 is a schematic assembly cross-section view. FIG. 19 illustrates mounting procedure for the panel illustrated in FIG. 18. The design is suited to extrusion construction and illustrates the peel minimisation layout.

FIG. 20 is a schematic assembly perspective view. FIG. 20 illustrates a kit of parts comprising a concertina folded strip of sewable material, which has a series of elongate panels joined to it. The kit also includes an array of mounting devices in the form of prior art hook-and-loop fasteners. These components are folded inside a sheet layer, for example made of paper or plastic, to separate them, and the paper or plastic layer is then able to be slidingly moved into an envelope.

FIG. 21A is a schematic perspective view of a strip of sewable material with adjacent panels joined to the one face of the strip and spaced apart from one another which creates a gap to allow the strip of sewable material to become folded in a concertina-like manner, and thus to overlay the panels in the form of a stack. FIG. 21B is a similar view to FIG. 21A except that the folding of the strip of material can also be achieved by having a perforation line formed at intervals within an elongate panel to allow the sewable material strip, and the panel, to be bent or folded about the perforation lines.

FIG. 22 is a schematic perspective view which illustrates a hanging apparatus comprising two panels 2201 and 2204 which are positioned on either side of a layer of sewable material 2203 which could be of an open weave nature to allow glue 2202 to pass therethrough and join both 2201 and 2204 at the sewable material 2203.

### DETAILED DESCRIPTION

This disclosure relates to the features of a fabric art hanging apparatus for mounting an item of fabric art. In the embodiments disclosed, the hanging apparatus can come in many shapes and forms, to be fit for purpose in the desired mounting arrangement.

In the following detailed description, terms of manufacture such as “bonded”, “adhesion”, and the term “fasteners” are used herein to simplify the description of the illustrated embodiments. However, because other terms, brand names and variations on the manufacture process and types of fasteners are possible, the present disclosure should not be limited to these terms of manufacture or to the terms used to describe the prior art in fasteners. Those skilled in the art will appreciate that other terms could be used to describe adhesives, manufacture methods or types of fasteners. “Bonded” refers to two things that have been adhered or joined together. “Adhesion” refers to the ability of one thing to stick firmly to another. “Fasteners” refers to a wide variety of devices that attach a first thing to another.

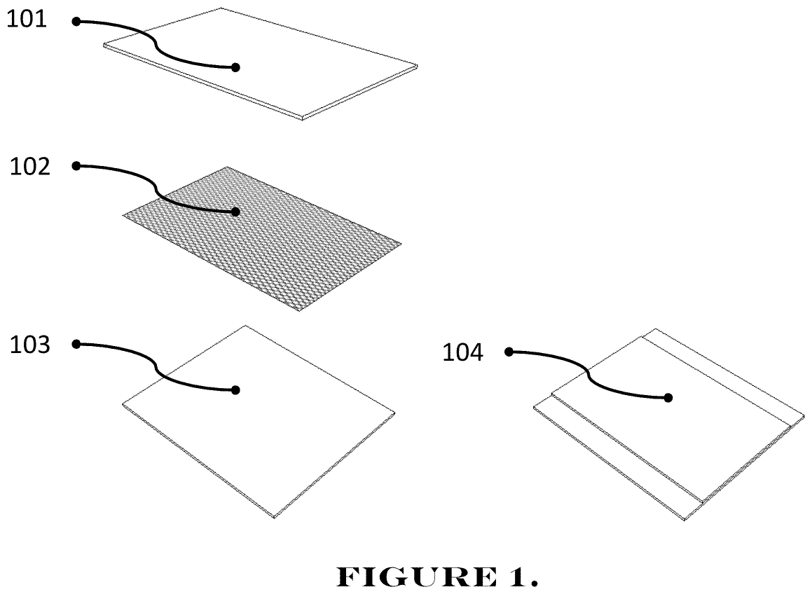

Referring to the illustrations, and initially to FIG. 1, the panel component 101 is formed of a plastic material, optimised on the top surface for receiving the adhesive formula of prior art fastener systems, which use or incorporate adhesion. Component 102 is an adhesive layer, which is formulated to achieve a desired bond between component 101 and a sewable material sheet. Component 103 is a sewable/pin-able material sheet layer. The design, size and placement of these components may vary, but the principle is of a product which intercedes between prior art mounting devices, which use or incorporate adhesion, and a second desired material (such as an item of fabric art) which does not possess the adhesion-receiving characteristics for which the prior art mounting device adhesive formula was optimised. The hanging apparatus 104 comprising these components 101, 102, 103 thereby achieves a desired bond between prior art mounting devices and the sewable item of fabric art.

In FIG. 1 an attachment system comprising components 101,102 and 103, is illustrated. The surface finish of the top surface of component 101 is presented for adhesion to prior art mounting devices such as hook and loop fasteners, clips etc. The bottom surface of component 101 has a surface finish optimised to receive and bond with component 102. This is achieved in one embodiment of component 101, by being constructed from, but not limited to, polyester material, and component 102 being constructed of, but not limited to, a heat-set adhesive formulation. The bottom component 103 is constructed as a fabric in sheet or tape form.

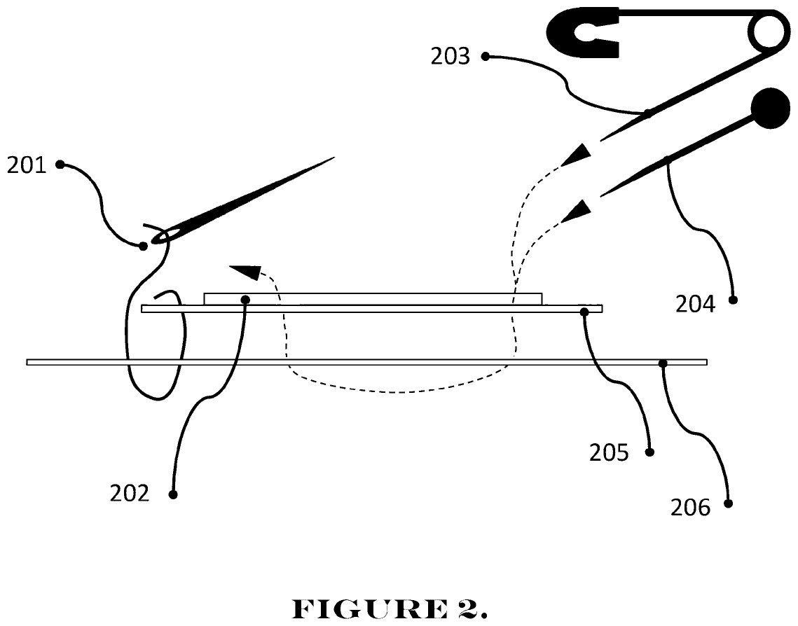

Referring to the embodiment of FIG. 2, the components are shown as separated, but they are aligned in a pre-assembly order. Item 201 represents a sewing attachment needle and thread, either performed by hand or by mechanical intervention. Items 203 and 204 represent two types of pinned attachment an alternative to sewing attachment. Prior art mounting devices are adhered to the top surface of the panel item 202, and these may include, but are not limited to, hook and loop, snaps, buckles, buttons, cable tie fixing mounts, clasps, or similar fasteners which may be one piece or may incorporate or require two or more pieces within the fastening system. The combined panel and sewable material component 202 intercedes between the prior art mounting device (not shown), and an adhesively non-compatible material represented by a fabric art item 205.

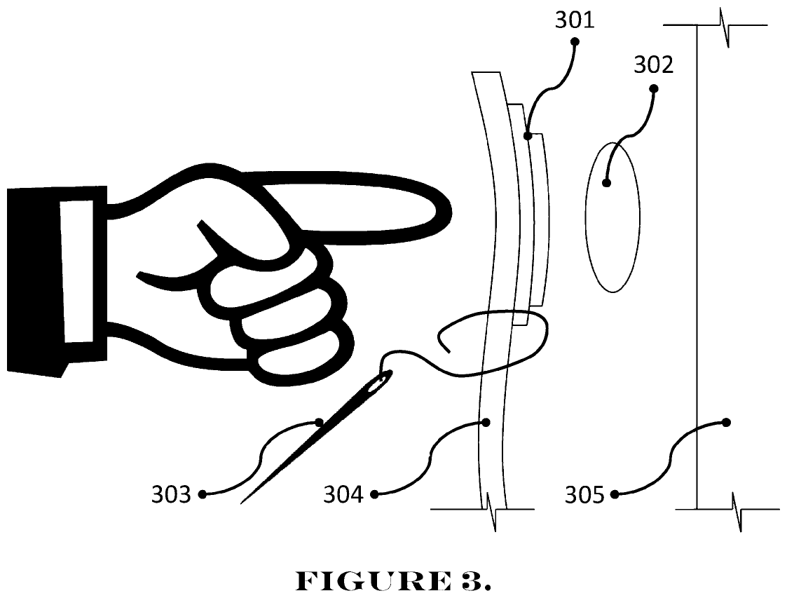

Referring to the embodiment of FIG. 3, Item 301 is a combined panel and sewable material component 301 which in use is linked via sewn attachment to item 304 representing an item of fabric art. Item 302 represents a prior art fastener, for example a pressure sensitive adhesive putty such as the product branded as Blu-Tack. Item 305 represents a wall or generic surface to which the fabric art product is to be fastened to.

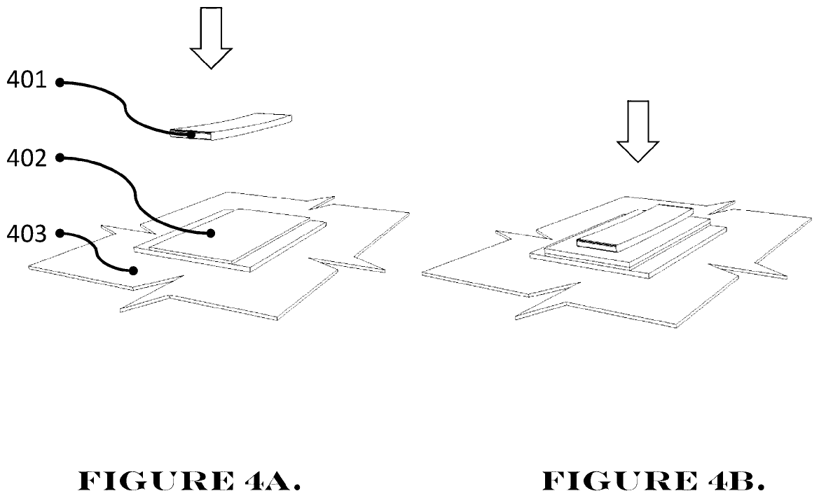

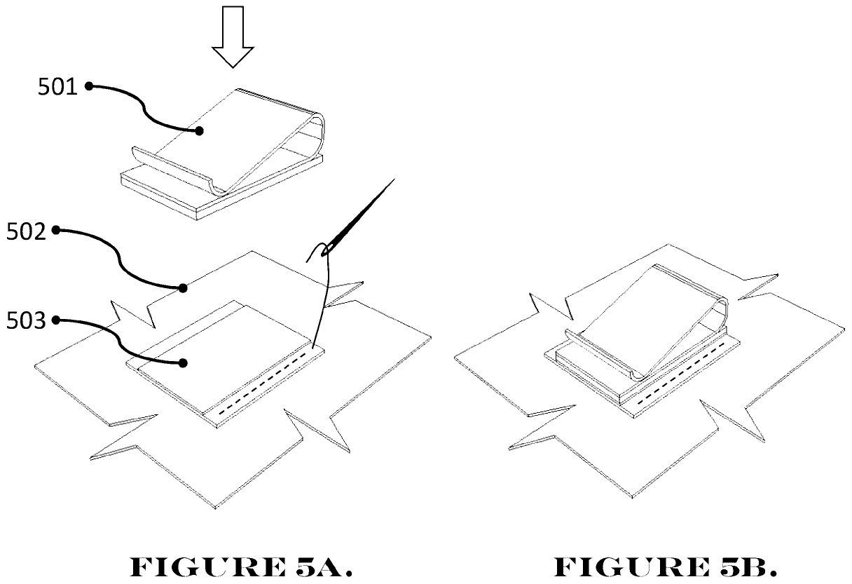

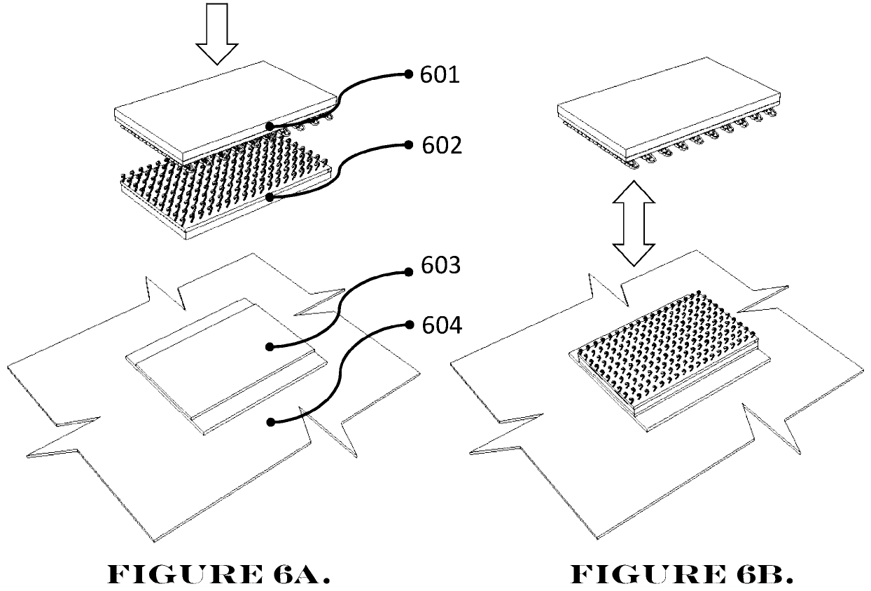

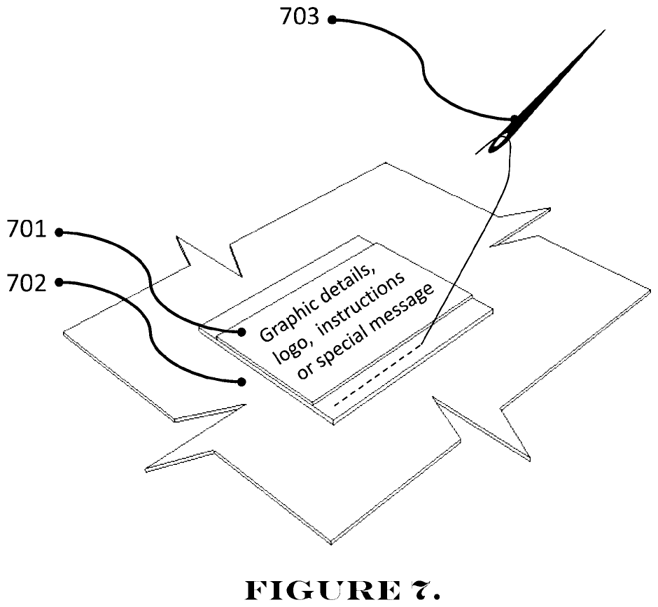

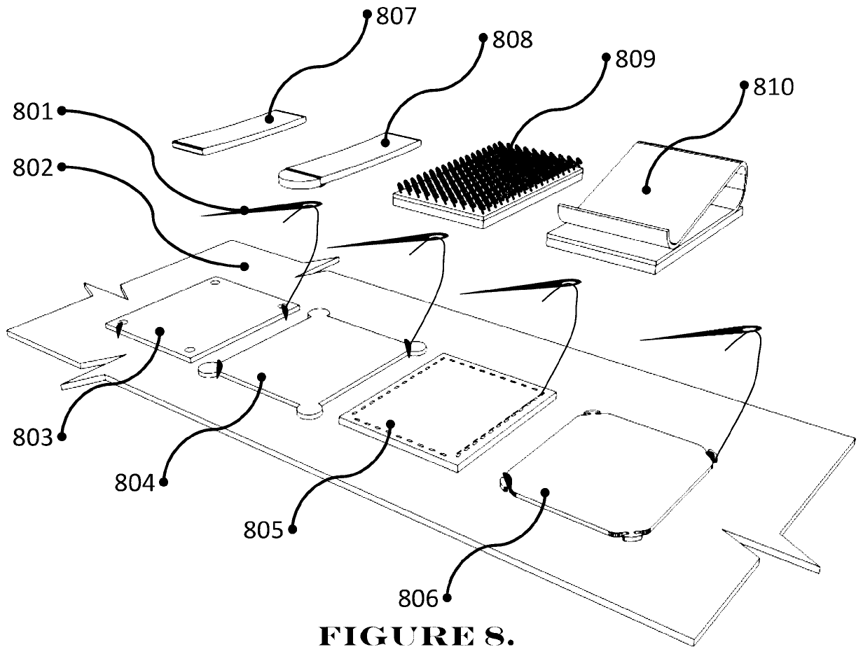

Referring to FIGS. 4A and 4B, in FIG. 4A the components are shown as separated but aligned in pre-assembly order, and FIG. 4B illustrates all of the components assembled ready to be attached to a desired surface (not shown) exemplified by a wall suitable for mounting via the prior art mounting device 401, which in this embodiment has an adhesive top surface. Item 401, is a generic illustration of a prior art mounting device which possess an adhesive surface on both sides, such as a reusable putty-like pressure-sensitive adhesive category of prior art fasteners (for example Blu-Tack brand), or by a removable laminate on a single-sided or double-sided adhesive tape that is stretchable to accomplish removal. Prior art fasteners both temporary and permanent in the double sided tape category have a variety of names and brandings. For item 401, hook and loop fasteners are also known, for example sold under the brand Commander Strips. Component 402 comprises a panel and a layer of sewable material glued together to form a hanging apparatus which is designed to intercede between a desired surface (not shown), and an adhesively non-compatible sewable material represented by an item of fabric art 403.

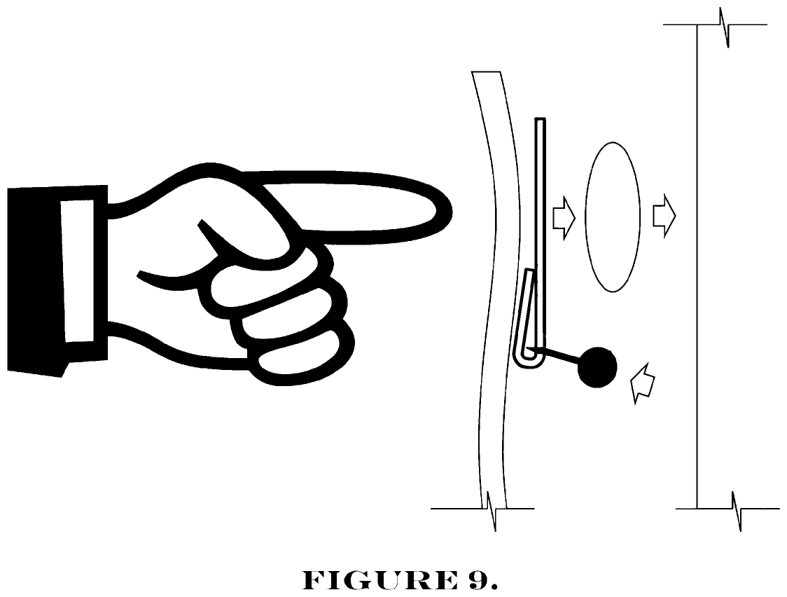

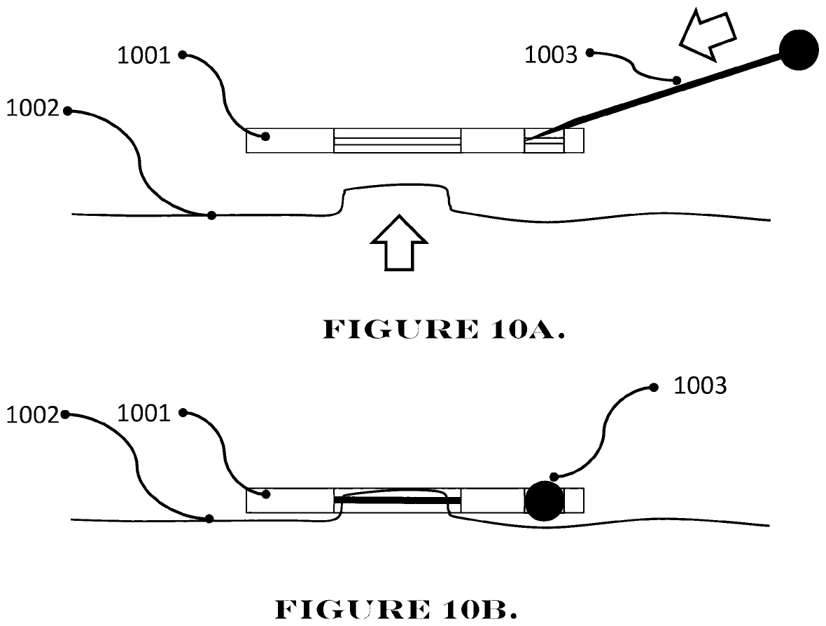

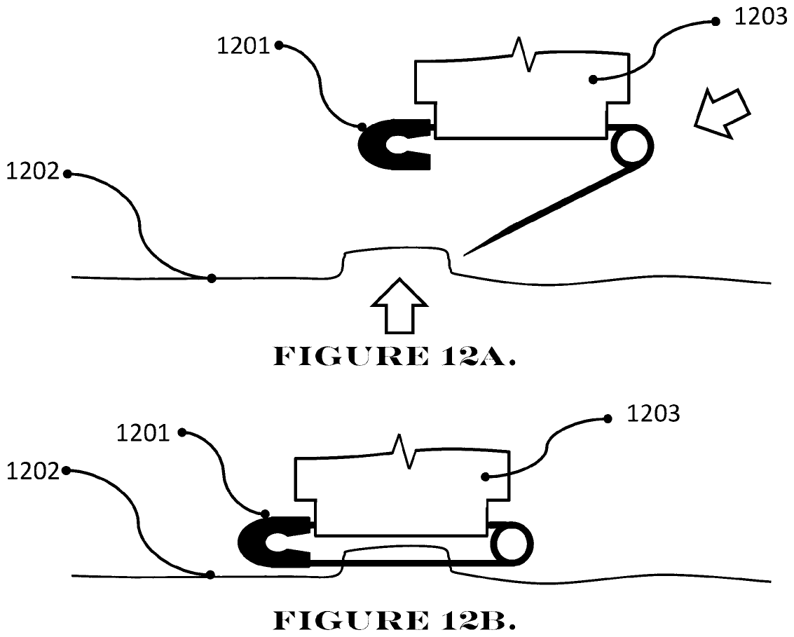

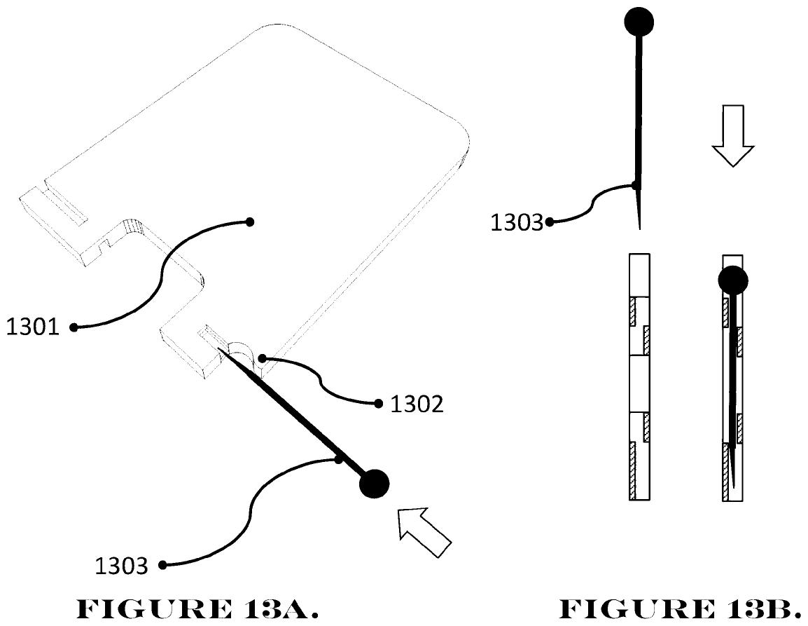

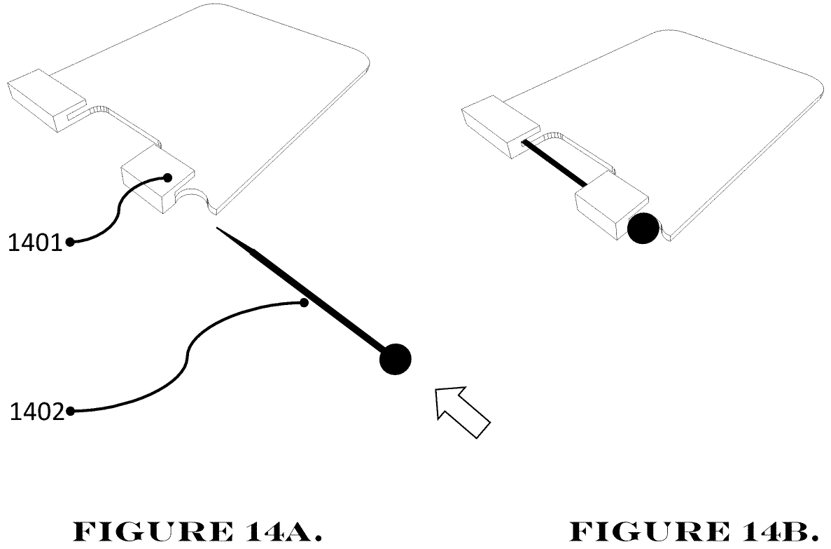

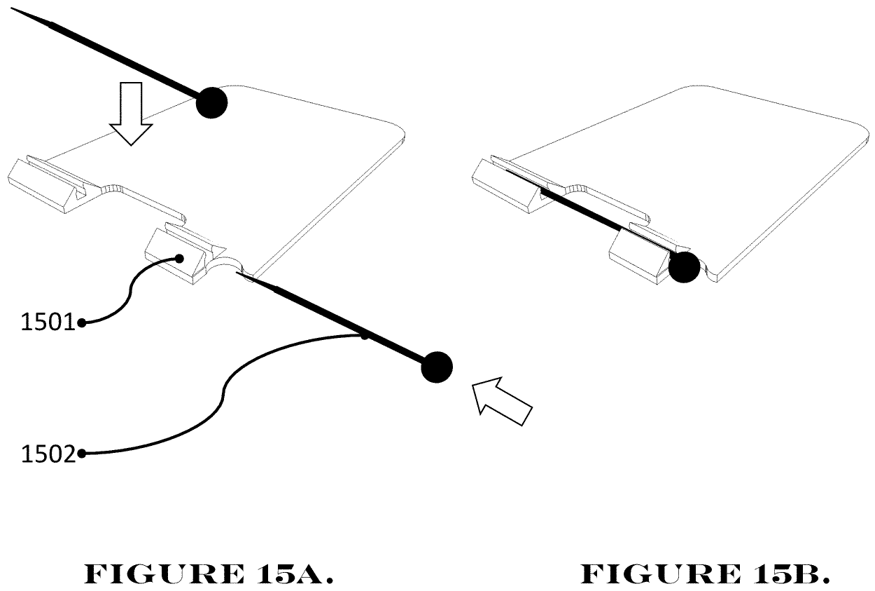

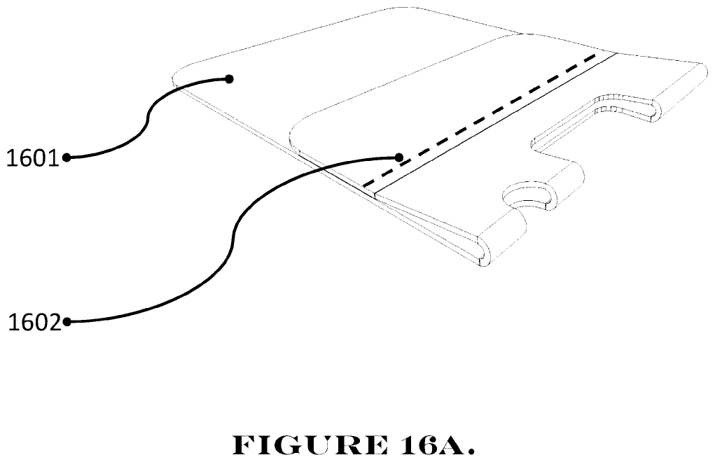

FIGS. 9 to FIG. 19 illustrate a variety of manufacture and assembly options for fabric art hanging apparatus. They all follow the same principle of a mechanically pinned attachment to the desired sewable material layer. The pins, or safety pins, form a link between the sewable fabric and the panel. The panel in turn forms a link between itself and the adhesive surface of a prior art mounting device. Options for injection moulding, press cutting, laser cutting and heat forming are illustrated.

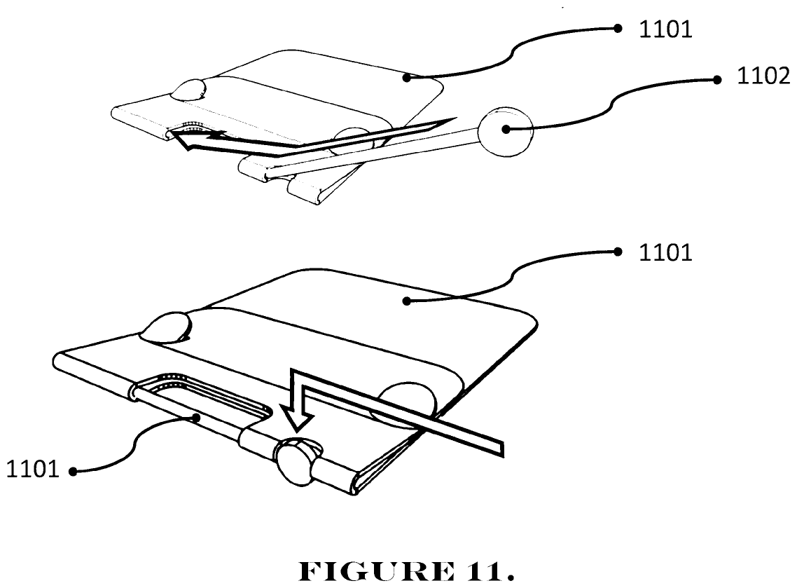

FIG. 11 illustrates a laser cut or die cut design, which uses interlocking tabs to facilitate assembly without the need for additional glues or heat processing.

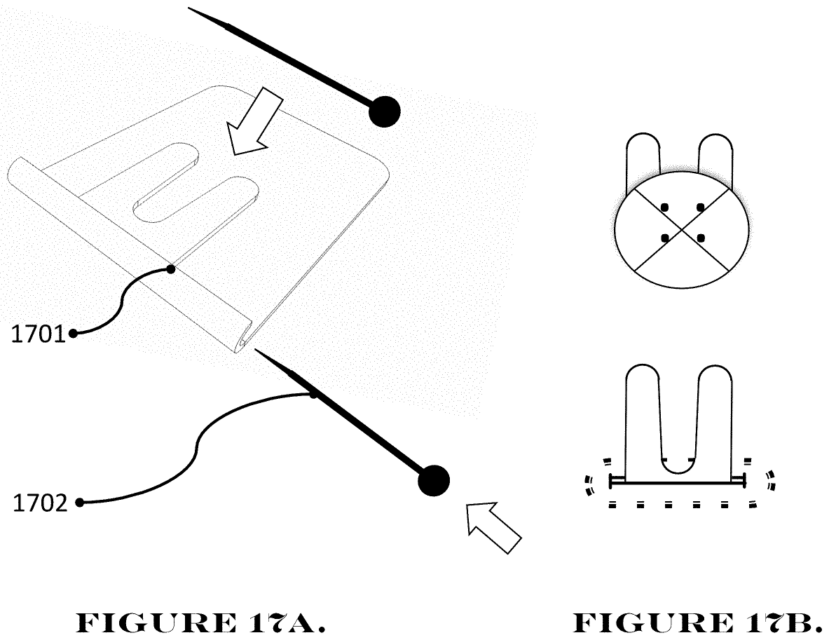

FIGS. 17A and 17B illustrate a sewn attachment via the use of a button or buttonhole.

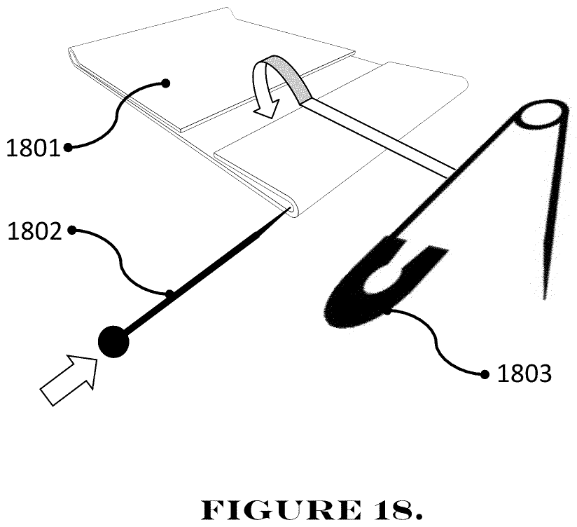

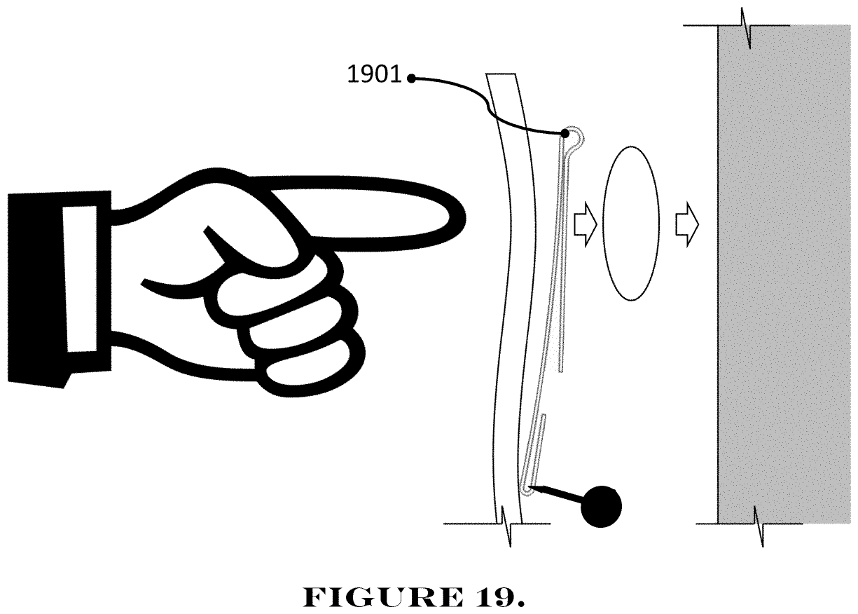

FIG. 18 and FIG. 19 illustrate a simple extruded panel with enhanced peel resistance.

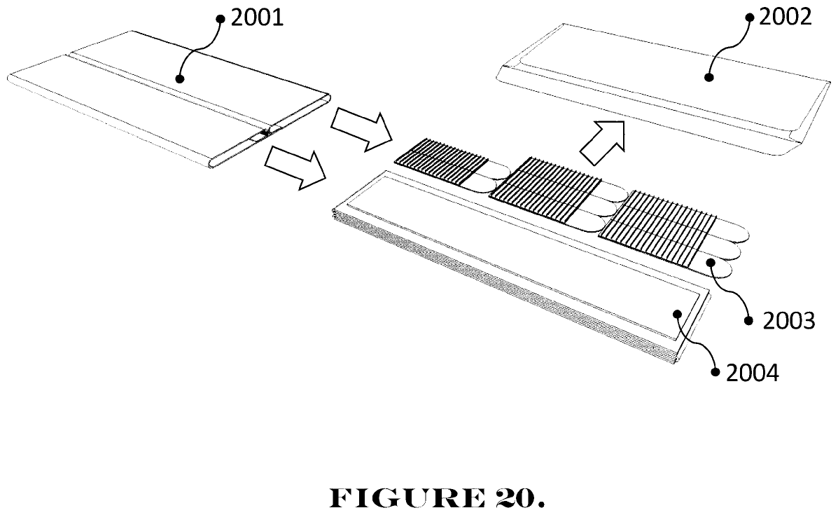

FIG. 20 illustrates a kit of parts comprising a concertina folded strip of sewable material, to which is joined a series of elongate panels, the strip and panels forming an elongate version of a fabric art hanging apparatus 2004. The kit also includes an array of mounting devices in the form of prior art hook-and-loop fasteners, arranged in rows on a support sheet 2003.

To form the kit, the mounting devices 2003 and the elongate, folded fabric art hanging apparatus 2004 are folded inside a paper or plastic sheet layer 2001 to separate them, and the paper or plastic layer 2001 is then able to be slidingly moved by a human operator or a machine into an envelope 2002. A feature of the packaging is that the two components 2004 and 2003 are held in a way that does not let them overlap. This can be done in lots of ways, but in this example it is done by folding a piece of paper 2001. Other ways include making gussets in a bag, for directly locating the parts into an end entry envelope or even temporary gluing the parts onto an insertion sheet. If the components 2003, 2004 overlap and are not separated to lie alongside one another, then there is the possibility that they will exceed the Post Office thickness limit for an envelope, and incur either extra cost, or will not be sent.

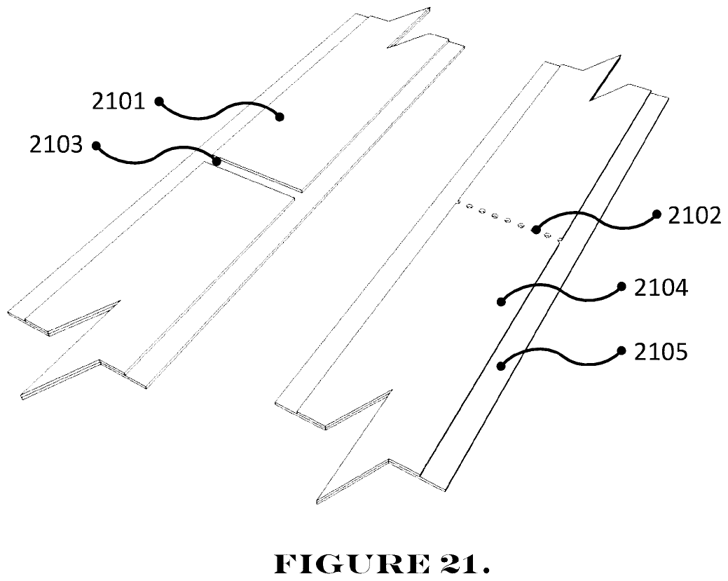

FIG. 21A is a schematic perspective view of a strip of sewable material with adjacent panels 2101 joined to the one face of the strip and spaced apart from one another which creates a gap 2103 to allow the strip of sewable material to become folded in a concertina-like manner, and thus to overlay each of the panels in the form of a stack. The panel 2101 is spaced apart from the adjacent panel by the gap 2103 needed to create the ability for the hanging apparatus to concertina.

FIG. 21B is a schematic perspective view of a strip of sewable material 2105 with a single elongate panel 2102 joined to the one face of the strip, and featuring a perforation 2104 of the panel 2102, or an aligned perforation that passes through both the panel 2102 and the sewable fabric base 2105, and located at intervals within the elongate panel 2102 to allow the strip of sewable material 2105 to become folded in a concertina-like manner, and thus to overlay the fractured portions of the panel 2102 in the form of a concertina stack. The size of fracture or perforations is variable depending on the exact specification of the materials used. It is also possible that the elongate panel could simply be scored so that upon bending, a fold is achieved at desired intervals.

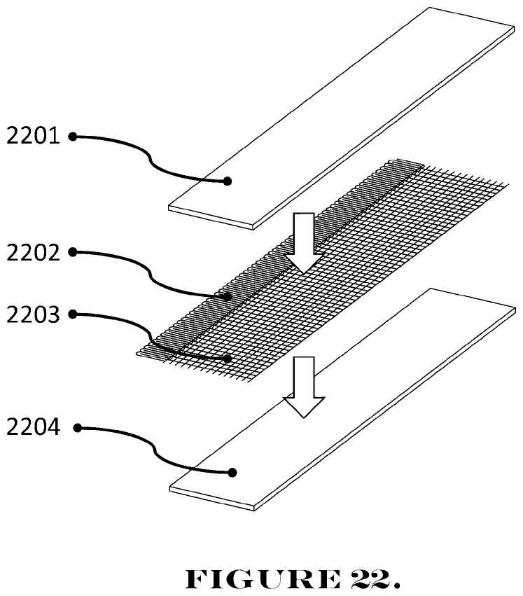

FIG. 22 is a schematic perspective view which illustrates a hanging apparatus comprising two panels 2201 and 2204 which are positioned on either side of a layer of sewable material 2203 which allows glue to pass therethrough and join both 2201 and 2204 at the sewable material 2203.

A panel 2201 has an uppermost surface which is suitable for adhesion to existing mounting devices. The panel 2201 is joined to the sewable material 2203 with an adhesive layer 2202 on its lower surface, and the fabric 2203 can be of an “open weave” type which allows the adhesive that is on the underside of panel 2201 to pass through it and join with (or become) the adhesive layer on the upper surface of panel 2204.

The panel 2204 is a backing layer which can be the same material as the panel 2201 or of a cheaper construction. The purpose of the panel 2204 is to stiffen the final construction and to provide a strong adhesion between panels 2201 and 2204 which embeds the sewable material 2203. The advantage of this arrangement overall is that a cheaper adhesive can be used while achieving a very strong bond with the fabric 2203.

The fabric layer 2203 has a portion extending beyond the perimeter of panels 2201 and 2204 for accepting pins or sewing, and which could extend beyond any or all of the four sides of either panel.

The hanging or mounting apparatus disclosed herein when sewn or pinned or otherwise attached to an item of fabric art provides a new and improved attachment between known prior art fasteners which use or incorporate adhesive, by diversifying their application for use on materials such as fabric art for which their adhesive formulations have not been optimised.

By using a layer of sewable material fabric, the mounting or hanging apparatus can intercede between an item of fabric art and a prior art fastener and be used in at least the following ways:
for mounting sewable products on surfaces such as painted wallboard, plaster, concrete, glass, metal or plastic. Fabric pieces or constructions can therefore be hung as wall hangings, or even attached to the glass or body of a vehicle. The hanging or mounting apparatus allows a diversity of prior art fasteners to be used as mounting devices;
joining or assembly applications;
positioning applications;
closure applications; and
permanent, semi-permanent and removable applications.

The particular construction of the hanging or mounting apparatus, for example the type of panel material used, the type of adhesive compositions, the size and positioning of holes, slots and tags to facilitate sewn application, or any combination thereof, can be varied to meet different requirements for each category of use.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

The reference in this specification to any prior publication or information is not, and should not be taken as, an acknowledgement or admission or any form of suggestion that the prior publication or information forms part of the common general knowledge in the field of endeavor to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A fabric art hanging apparatus, arranged in use for mounting an item of fabric art at a support structure, the hanging apparatus comprising:
a panel of flexible and bendable resilient material, the panel having opposed major faces suitable for receiving and bonding to an adhesive substance;
a layer of a sewable material affixed to one face of the panel; and
the layer of sewable material arranged with at least one portion extending beyond a perimeter of the panel;
wherein the face of the panel opposite to the one face is adapted in use for receiving and bonding to an adhesive substance, placed by a user locating a mounting device thereat, and the portion of the layer of sewable material is arranged in use for sewing to the item of fabric art.

2. The fabric art hanging apparatus as claimed in claim 1, wherein the layer of sewable material is affixed to the one face of the panel by an adhesive substance.

3. The fabric art hanging apparatus as claimed in claim 1, wherein the panel is of an elongate planar shape, having two opposed elongate sides.

4. The fabric art hanging apparatus as claimed in claim 3, wherein the panel is able to be deformed orthogonally relative to its central elongate axis.

5. The fabric art hanging apparatus as claimed in claim 3, wherein the layer of sewable material is arranged with portions extending beyond each of the two opposed elongate sides of the panel.

6. The fabric art hanging apparatus as claimed in claim 3, wherein the panel is formed from a PET polyester plastic material.

7. The fabric art hanging apparatus as claimed in claim 6, wherein the panel is of a width between opposed elongate sides sufficient to prevent the panel from twisting along its length in use.

8. The fabric art hanging apparatus as claimed in claim 1, wherein the sewable material is made of a fabric.

9. The fabric art hanging apparatus as claimed in claim 8, wherein the sewable material is formed from a grosgrain fabric.

10. The fabric art hanging apparatus as claimed in claim 1, wherein the hanging apparatus comprises a plurality of panels, arranged on the layer of sewable material in a spaced apart manner.

11. The fabric art hanging apparatus as claimed in claim 1, wherein the hanging apparatus comprises a panel arranged on the layer of sewable material, the panel having any one or more of the following lines of: breakage, folding, perforation or frangibility.

12. The fabric art hanging apparatus as claimed in claim 10, wherein the layer of sewable material is a strip of material, and the or each of the panels are of an elongate planar shape being arranged with portions of the sewable material extending beyond each of the two opposed elongate sides of the panel(s).

13. The fabric art hanging apparatus as claimed in claim 10, wherein each panel has a central axis and is arranged in an end-to-end, axially aligned manner.

14-15. (canceled)

16. A mounting apparatus for mounting to a sewable object, the mounting apparatus comprising:
a panel of flexible and bendable resilient material, the panel having an elongate planar shape, two opposed elongate sides, two opposed major faces suitable for receiving and bonding to an adhesive substance, and any one or more of the following lines of: breakage, folding, perforation or frangibility;
a layer of a sewable material joined to one face of the panel; and
the layer of sewable material arranged with at least one portion extending beyond a perimeter of the panel;
wherein the face of the panel opposite to the one face is adapted in use for receiving and bonding to an adhesive substance, placed by a user locating a mounting device thereat, and the portion of the layer of sewable material is arranged in use for sewing to the sewable object.

17. The mounting apparatus as claimed in claim 16, wherein the layer of sewable material is a strip of material, being arranged with portions extending beyond each of the two opposed elongate sides of the panel.

18-20. (canceled)

21. A fabric art hanging apparatus as claimed in claim 11, wherein the layer of sewable material is a strip of material, and the or each of the panels are of an elongate planar shape being arranged with portions of the sewable material extending beyond each of the two opposed elongate sides of the panel(s).

22. A fabric art hanging apparatus, arranged in use for mounting an item of fabric art at a support structure, the hanging apparatus comprising:
a panel having opposed major faces suitable for receiving and bonding to an adhesive substance;
a layer of a sewable material which is supplied affixed by a physical bond to one face of the panel, so that in use the sewable material and the panel are moveable together as one; and
the layer of sewable material arranged with at least one portion extending beyond a perimeter of the panel;
wherein the face of the panel opposite to the one face is adapted in use for receiving and bonding to an adhesive substance, placed by a user locating a mounting device thereat, and the portion of the layer of sewable material is arranged in use for sewing to the item of fabric art.

23. The fabric art hanging apparatus as claimed in claim 22, wherein the panel is comprised of a flexible and bendable resilient material.

24. The fabric art hanging apparatus as claimed in claim 22, in which the panel further comprises an elongate planar shape, having two opposed elongate sides and a width between said opposed elongate sides sufficient to prevent the panel from twisting along its length in use.

25. A mounting apparatus for mounting to a sewable object, the mounting apparatus comprising:
a panel having an elongate planar shape, two opposed elongate sides, two opposed major faces suitable for receiving and bonding to an adhesive substance, and any one or more of the following lines of: breakage, folding, perforation or frangibility;
a layer of a sewable material which is supplied affixed by a physical bond to one face of the panel, so that in use the sewable material and the panel are moveable together as one; and
the layer of sewable material arranged with at least one portion extending beyond a perimeter of the panel;
wherein the face of the panel opposite to the one face is adapted in use for receiving and bonding to an adhesive substance, placed by a user locating a mounting device thereat, and the portion of the layer of sewable material is arranged in use for sewing to the sewable object.
